(19) United States
(12) Patent Application Publication
(10) Pub. No.: US 2017/0136966 A1
(43) Pub. Date: May 18, 2017

(54) DECKLID TRIM INTERLOCKING FEATURE

(71) Applicant: FORD GLOBAL TECHNOLOGIES, LLC, Dearborn, MI (US)

(72) Inventors: Gian Carlo Morlet Ugalde, Huixquilucan (MX); David Conejos Carrasco, Sagunt (ES); Santiago Manuel Parra Becerra, Ocoyoacac (MX); Pablo Naderpour Penalver, Valencia (ES)

(21) Appl. No.: 14/941,268

(22) Filed: Nov. 13, 2015

(51) Int. Cl. B60R 13/02; B62D 25/12

(52) U.S. Cl. CPC B60R 13/0206; B62D 25/12

(57) ABSTRACT

A trim piece for a motor vehicle includes a cutout portion for receiving a vehicle member and an overlapping interlocking joint for securing the cutout portion around the vehicle member. The overlapping interlocking joint includes a flanged male portion and a cooperating female portion. The cooperating female portion may be defined on an edge of the overlapping interlocking joint or in an interior of the overlapping interlocking joint. The trim piece may be fabricated in whole or in part of a flexible material, and may be configured for attaching to a variety of structures such as a bottom surface of a decklid or to a trunk interior surface.

### TECHNICAL FIELD

This disclosure relates generally to trim pieces for motor vehicles. More particularly, the disclosure relates to a trim piece including an interlocking feature for securing the trim piece about a vehicle element such as a decklid hinge.

### BACKGROUND

Trim pieces are used to provide an attractive, finished appearance to certain areas of a vehicle, including open cargo areas such as in a sport-utility vehicle and also closed cargo areas such as trunk and decklid of a sedan. A variety of materials are known for fabricating such trim pieces, including various soft materials such as cloth/fabric, plastics or polymers, and combinations. Wiring, connections, latch mechanisms, bare metal surfaces, welds, etc. may be covered by the trunk trim piece or pieces, and by the decklid trim piece or pieces attached to the decklid.

In order to provide an acceptable fit, certain portions of the trim piece must be wrapped around certain vehicle elements during installation. For example, during vehicle manufacture a decklid trim piece must be wrapped around elements of the decklid/trunk such as the hinge elements connecting the decklid to the trunk cargo area. During installation, an operator must open the corners of the trim piece, begin installing the trim piece, configure any necessary wiring connections, wrap the open portions around the hinges, and close the open corners.

As shown in FIG. 1A depicts a prior art motor vehicle 100 decklid trim piece 102 attached to a decklid 104. Typically the decklid trim piece 102 includes one or more cut-outs 105 (see FIG. 1B) for accommodating or accessing various vehicle elements such as latch mechanisms, wiring harnesses, etc. during installation of the trim piece. The trim piece 102 as depicted also includes a corner hinge cut-out portion 106 through which a decklid hinge element 108 passes.

With reference to FIG. 1B, for ease of assembly the trim piece 102 includes a separable portion 110 connected to the corner hinge cut-out portion 106 which may be separated to wrap around the decklid hinge element 108. The separable portion 110 also usually includes a mating puzzle feature 112 designed to interlock and retain the separable portion wrapped around the decklid hinge element 108. However, while substantially effective for its intended purpose, conventional mating puzzle features 112 for decklid trim pieces 102 often do not properly mate and may separate slightly, leaving unsightly gaps G (see FIG. 1C) which a consumer may associate with poor fit and finish of the vehicle.

Accordingly, the present disclosure relates to an improved motor vehicle trim piece such as for a motor vehicle decklid or trunk area. Advantageously, the described trim piece incorporates an interlocking feature providing improved retention about certain motor vehicle features such as hinge elements.

### SUMMARY

In accordance with the purposes and benefits described herein, in one aspect of the present disclosure a trim piece for a motor vehicle is provided, comprising a cutout portion for receiving a vehicle member and an overlapping interlocking joint for securing the cutout portion around the vehicle member. The overlapping interlocking joint includes a flanged male portion and a cooperating female portion. The trim piece may be fabricated of a flexible material.

In embodiments, the cooperating female portion is defined on an edge of the overlapping interlocking joint. In alternative embodiments, the cooperating female portion is defined in an interior of the overlapping interlocking joint. In embodiments, the trim piece may be configured for attaching to a bottom surface of a decklid or to a trunk interior surface.

In another aspect, an overlapping interlocking joint for a motor vehicle trim piece is described.

In the following description, there are shown and described embodiments of the disclosed motor vehicle trim piece. As it should be realized, the trim piece is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed trim piece for a motor vehicle, and together with the description serve to explain certain principles thereof. In the drawing:

FIG. 1A shows a vehicle decklid and trunk including a prior art trim piece;

FIG. 1B shows a prior art trim piece configured for attaching to a decklid bottom surface;

FIG. 1C shows an isolated view of a mating puzzle feature for the trim piece of FIG. 1B;

FIG. 2A depicts a trim piece including an overlapping interlocking joint according to the present disclosure;

FIG. 2B depicts an alternative embodiment of the overlapping interlocking joint of FIG. 2A; and

FIG. 2C depicts the overlapping interlocking joint of the present disclosure affixed around a decklid hinge element.

Reference will now be made in detail to embodiments of the disclosed improved trim piece for a motor vehicle, examples of which are illustrated in the accompanying drawing figures.

### DETAILED DESCRIPTION

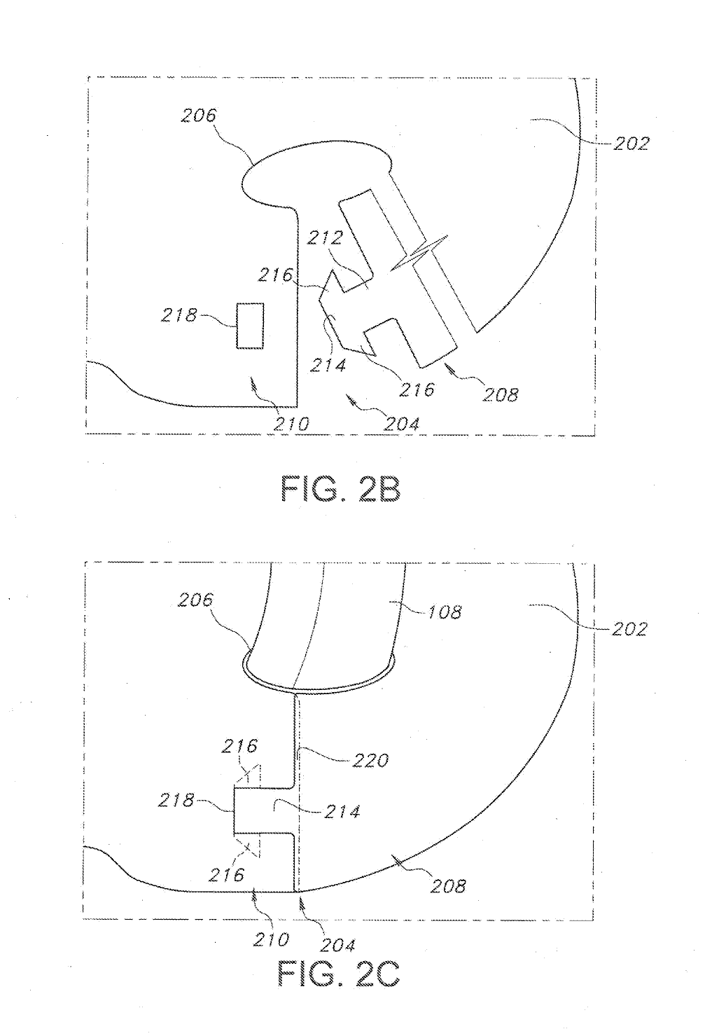

To solve the foregoing and other problems, with reference to FIGS. 2A-2C there is shown a vehicle trim piece 202 according to the present disclosure, including an overlapping interlocking joint 204. The trim piece 202 includes also a cut-out portion 206, in the depicted embodiment being configured for a vehicle member such as a gooseneck hinge (not shown).

The overlapping interlocking joint 204 includes a flanged male portion 208 and a cooperating female portion 210. The flanged male portion 208 includes a neck 212 and a head 214 including flanges 216 configured for engaging the cooperating female portion 210. In turn, the cooperating female portion 210 defines a receiver 218 for capturing the flanged male portion head 214. As will be appreciated, any suitable configuration for the head 214 and receiver 218 is contemplated, to provide a desired mating fit as will be described.

In the depicted embodiment, the cooperating female portion 210 may have an open configuration including a receiver 218 defined in an edge of the material of the trim piece 202. However, as will be appreciated, alternative embodiments are possible. As one non-limiting alternative example, as shown in FIG. 2B the cooperating female portion 210 has a closed configuration including a receiver 218 defined within an interior of the trim piece 202.

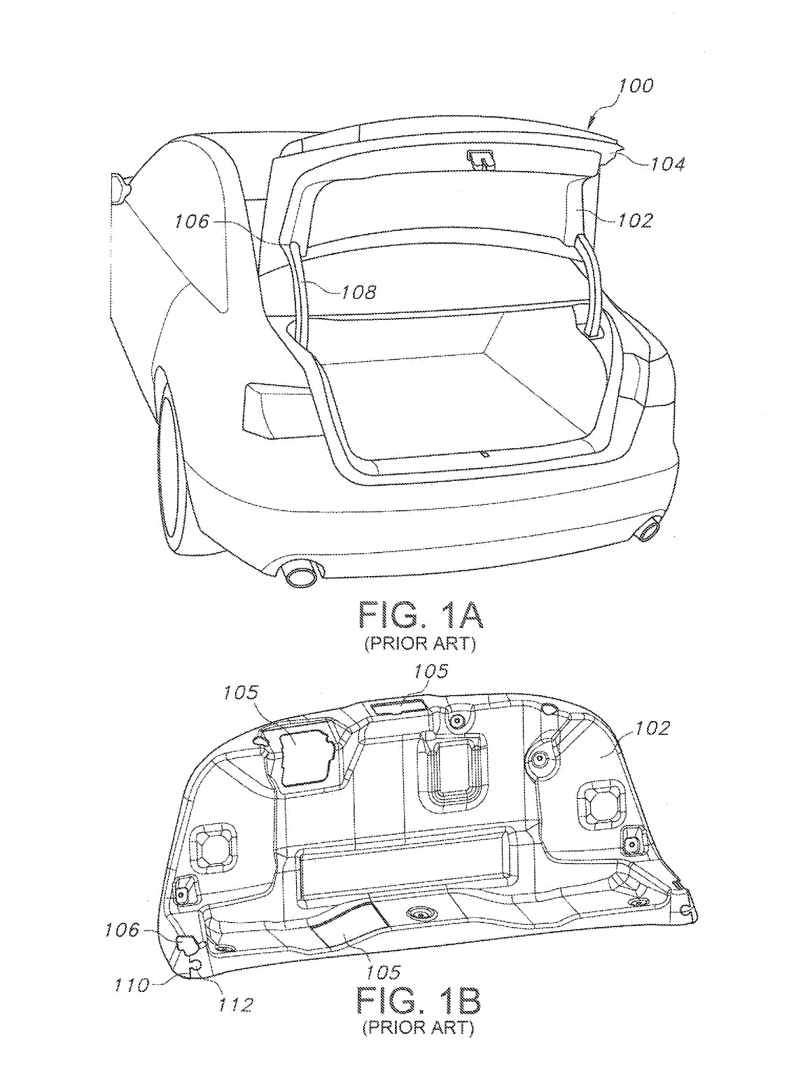

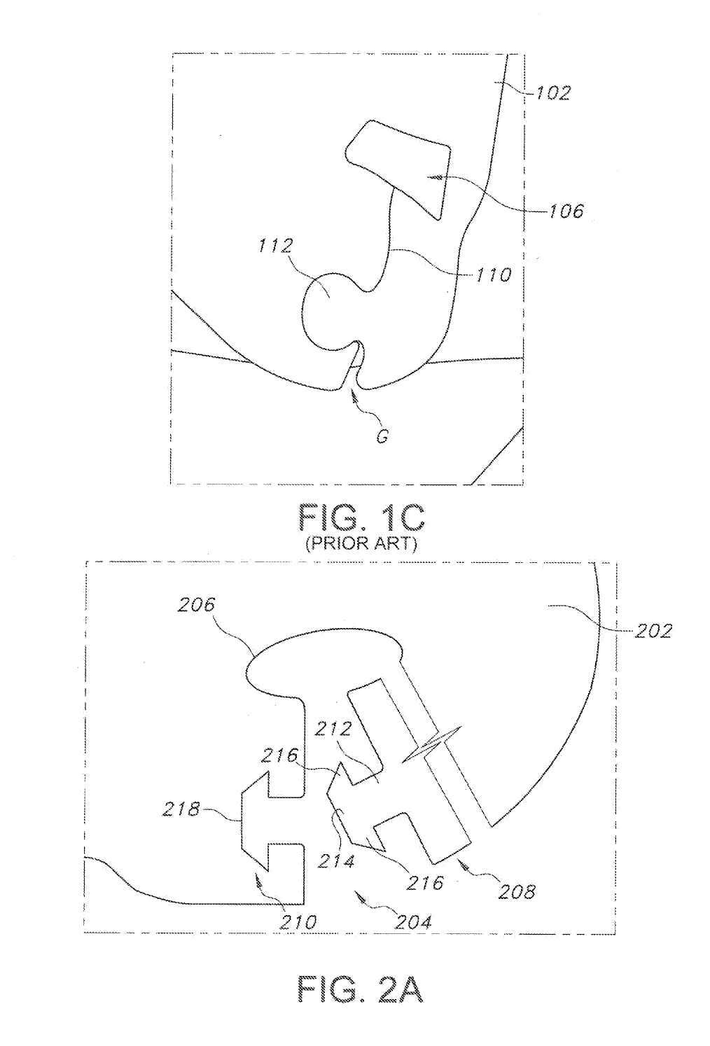

As shown in FIG. 2C, to secure the trim piece 202 about a vehicle member such as a decklid gooseneck hinge 108, it is necessary only to insert the flanged male portion head 214 into the cooperating female portion receiver 218 whereby the flanges 216 engage the receiver to provide a suitable mating fit. As shown, the flanged male portion 208 is dimensioned whereby when the flanges 216 engage the receiver 218, an overlap 220 is provided between the material of the trim piece flanged male portion 208 and the cooperating female portion 210. By this overlap 220, gaps and misalignments as occur with conventional mating puzzle features 112 for decklid trim pieces 102 (see FIG. 1B) are avoided. As will be appreciated, various configurations are possible for the overlap 220, including configurations similar to a full lap joint or a partial lap joint. Such structures are well known in the art.

Obvious modifications and variations are possible in light of the above teachings. For example, the disclosed motor vehicle trim piece is described herein primarily in an embodiment associated with a trim piece for attachment to a bottom surface of a decklid or a trunk area interior surface. However, it will be appreciated that the trim piece is readily integrated into any motor vehicle surface having a feature to be received in the described cutout, for example a motor vehicle trunk interior surface, a vehicle surface adjacent a seatbelt attachment point, a vehicle surface adjacent a seat attachment point, and others. Therefore, the disclosure should not be taken as limiting in this respect. All such modifications and variations are within the scope of the appended claims when interpreted in accordance with the breadth to which they are fairly, legally and equitably entitled.

1. A trim piece for a motor vehicle, comprising;
a cutout portion for receiving a vehicle member; and
a flexible overlapping interlocking joint for securing the cutout portion around the vehicle member.

2. The trim piece of claim 1, wherein the overlapping interlocking joint includes a flanged male portion and a cooperating female portion.

3. The trim piece of claim 2, wherein the cooperating female portion is defined on an edge of the overlapping interlocking joint.

4. The trim piece of claim 2, wherein the cooperating female portion is provided as a closed receiver defined in an interior of the overlapping interlocking joint.

5. The trim piece of claim 1, including at least a portion fabricated of a flexible material.

6. The trim piece of claim 1, configured for attaching to a bottom surface of a decklid or to a trunk interior surface.

7. A motor vehicle including the trim piece of claim 1.

8. A trim piece for a motor vehicle, comprising;
a cutout portion for receiving a vehicle member; and
an overlapping interlocking joint for securing the cutout portion around the vehicle member, comprising a flanged male portion and a cooperating female portion.

9. The trim piece of claim 8, wherein the cooperating female portion is defined on an edge of the overlapping interlocking joint.

10. The trim piece of claim 8, wherein the cooperating female portion is provided as a closed receiver defined in an interior of the overlapping interlocking joint.

11. The trim piece of claim 8, including at least a portion fabricated of a flexible material.

12. The trim piece of claim 8, configured for attaching to a bottom surface of a decklid or to a trunk interior surface.

13. A motor vehicle including the trim piece of claim 8.

14. An overlapping interlocking joint for a motor vehicle trim piece, comprising:
a flanged male portion; and
a cooperating female portion.

15. The overlapping interlocking joint of claim 14, wherein the cooperating female portion is defined on an edge of the overlapping interlocking joint.

16. The overlapping interlocking joint of claim 14, wherein the cooperating female portion is provided as a closed receiver defined in an interior of the overlapping interlocking joint.

17. The overlapping interlocking joint of claim 14, fabricated of a flexible material.

18. A motor vehicle trim piece including the overlapping interlocking joint of claim 14.

19. A motor vehicle including the trim piece of claim 18.
